(19) United States
(12) Patent Application Publication
(10) Pub. No.: US 2026/0236368 A1
(43) Pub. Date: Aug. 13, 2026

(54) METHOD AND SYSTEM FOR FAST-FOURIER-TRANSFORM-BASED TEST DATA FOR TIME SERIES MODELS

(71) Applicants: Sudhan Mani, Chennai (IN); Ashok Mugundu Balan, Madurai (IN)

(72) Inventors: Sudhan Mani, Chennai (IN); Ashok Mugundu Balan, Madurai (IN)

(73) Assignee: Kinaxis Inc., Ottawa (CA)

(21) Appl. No.: 19/397,040

(22) Filed: Nov. 21, 2025

Related U.S. Application Data
(60) Provisional application No. 63/723,179, filed on Nov. 21, 2024.
(60) Provisional application No. 63/723,214, filed on Nov. 21, 2024.

(51) Int. Cl. G06F 11/3604

(52) U.S. Cl. CPC G06F 11/3604

(57) ABSTRACT

Systems and methods for constructing comprehensive test suites for time series machine-learning models are disclosed. The approach leverages frequency-domain analysis to ensure robust coverage and adversarial resilience. A Fast Fourier Transform (FFT) is performed on time series in a test set to extract dominant spectral features, including frequencies, amplitudes, and phases. These features are clustered to group time series with similar temporal patterns, enabling stratified sampling for broad coverage across seasonal and periodic behaviors. Outlier clusters are identified to include rare or edge-case patterns. Additionally, adversarial test cases are generated by perturbing spectral components of sampled time series and reconstructing modified signals via inverse FFT, preserving temporal structure while introducing controlled variations. The resulting test suite integrates representative samples, outlier cases, and adversarial examples, providing a unified pipeline for rigorous evaluation of forecasting models. Implementations include computer-implemented methods, systems, and non-transitory computer-readable media.

This application claims priority on U.S. Provisional Patent Application 63/723,179 filed on Nov. 21, 2024, and on U.S. Provisional Patent Application 63/723,622 filed on Nov. 21, 2024, each of which is incorporated herein in its respective entirety, by reference.

### BACKGROUND

Test coverage measures how thoroughly a codebase or system is evaluated by a test suite, typically expressed as a percentage of executed code lines, branches, or paths. For machine learning (ML) products, good test coverage involves ensuring that tests encompass a broad range of input data to validate a model's performance across diverse scenarios, including edge cases. In order to achieve this, test data must represent a wide variety of conditions, demographics, and corner cases. One way to ensure this is by creating a test set that includes samples not seen during training, while applying techniques such as stratified sampling to maintain diversity across demographic groups and other relevant data conditions.

When it comes to time series machine learning models—designed to handle sequential data collected over time—achieving comprehensive test coverage becomes more technically challenging due to the temporal patterns often present in the data, such as trends and seasonality. Standard sampling techniques used for other ML models may not sufficiently capture these time-dependent characteristics. Therefore, additional care is required to ensure the test suite accounts for time-based behaviors and patterns within the data.

### BRIEF SUMMARY

Disclosed herein are systems and methods that allow for achieving comprehensive test coverage of time series machine learning modules, including technical challenges due to temporal patterns present in the data, such as trends and seasonality. Systems and methods disclosed herein are able to address these technical challenges by capturing these time-dependent characteristics, and ensuring that the test suite can account for time-based behaviors and patterns within the data.

Disclosed herein are systems and methods that use Fast Fourier Transform (FFT) to analyze time series in the frequency domain, extracting top K dominant frequencies, amplitudes, and phases as temporal signatures. Such a FFT-Based Feature Extraction is not just for feature engineering, but specifically for test suite construction, which is uncommon in traditional ML testing.

Disclosed herein are systems and methods that provide clustering by spectral attributes; time series are grouped into clusters based on their frequency-domain characteristics (seasonality, periodicity, etc.). This enables stratified sampling across these clusters to ensure coverage of diverse temporal patterns, which standard random sampling cannot guarantee.

Disclosed herein are systems and methods that provide automated adversarial test case generation. Adversarial examples are created by perturbing the extracted spectral components (frequencies, amplitudes, phases, etc.), and the reconstructing realistic time series via inverse FFT, preserving temporal structure while introducing subtle changes to stress-test models.

Disclosed herein are systems and methods that provide unified pipeline for coverage and edge cases. Three streams are combined into one automated test suite, that includes coverage samples (representative clusters), adversarial samples (perturbed spectra), and outlier clusters (rare temporal patterns). In this manner, a comprehensive and systematic approach to testing time series ML models is provided.

Disclosed herein are systems and methods that provide scalability for multi-horizon forecasting, and are designed for large-scale scenarios (hundreds of thousands of time series) with multi-horizon forecasting, ensuring robust backtesting before deployment.

In one aspect, a computing apparatus is provided, that includes a processor. The computing apparatus also includes a memory storing instructions that, when executed by the processor, configure the apparatus to: perform a Fast Fourier Transform (FFT) on a second set of time series in a test set; extract top ‘K’ amplitudes and corresponding frequencies and phases of the FFT; generate clusters by performing clustering on extracted spectral features; perform stratified sampling on the clusters; extract a first time series from the stratified sampling, the first time series corresponding to temporal pattern coverage’ and output the first time series into the test suite.

The computing apparatus may also include where the instructions further configure the apparatus to pre-process each time series in the test set before performing the FFT, by at least one of: detrending, deseasonalizing, windowing, normalization, or zero-padding. When extracting the spectral features, the instructions may further configure the apparatus to normalize amplitudes by a total spectral power of a respective time series. When generating the clusters, the instructions may further configure the apparatus to apply a clustering algorithm selected from the group consisting of k-means, hierarchical agglomerative clustering, Density-Based Spatial Clustering of Applications with Noise (DBSCAN), Gaussian mixture models, and spectral clustering. When performing stratified sampling, the instructions may further configure the apparatus to allocate samples proportional to cluster membership and enforce a minimum number of samples per cluster.

The computing apparatus may also include where the instructions further configure the apparatus to: sample one or more outlier clusters; extract a second time series corresponding to an outlier test case from sampling of the one or more outlier clusters; and combine the first time series and the second time series into the test suite. The computing apparatus may also include where the instructions further configure the apparatus to identify the one or more outlier clusters based on at least one criterion selected from singleton membership, silhouette score threshold, cluster density threshold, or distance from a cluster centroid exceeding a percentile. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to: perform a Fast Fourier Transform (FFT) on a second set of time series in a test set; extract top ‘K’ amplitudes and corresponding frequencies and phases of the FFT; generate clusters by performing clustering on extracted spectral features; perform stratified sampling on the clusters; extract a first time series from the stratified sampling, the first time series corresponding to temporal pattern coverage’ and output the first time series into the test suite.

The computer-readable storage medium may also include where the instructions further configure the computer to pre-process each time series before performing the FFT in the test set, by at least one of: detrending, deseasonalizing, windowing, normalization, or zero-padding. When extracting the spectral features, the instructions may further configure the computer to normalize amplitudes by a total spectral power of a respective time series. When generating the clusters, the instructions may further configure the computer to apply a clustering algorithm selected from the group consisting of k-means, hierarchical agglomerative clustering, Density-Based Spatial Clustering of Applications with Noise (DBSCAN), Gaussian mixture models, and spectral clustering. When performing stratified sampling, the instructions may further configure the computer to allocate samples proportional to cluster membership and enforce a minimum number of samples per cluster.

The computer-readable storage medium may also include where the instructions further configure the computer to: sample one or more outlier clusters, extract a second time series corresponding to an outlier test case from sampling of the one or more outlier clusters, and combine the first time series and the second time series into the test suite. The computer-readable storage medium may also include where the instructions further configure the computer to identify the one or more outlier clusters based on at least one criterion selected from singleton membership, silhouette score threshold, cluster density threshold, or distance from a cluster centroid exceeding a percentile. Other technical features may be readily apparent to one skilled in the art from the following figures, descriptions, and claims.

In one aspect, a computer-implemented method is provided for generating a test suite for evaluating one or more machine-learning models trained on a first set of time series. The method includes: performing a Fast Fourier Transform (FFT) on a second set of time series in a test set; extracting top ‘K’ amplitudes and corresponding frequencies and phases of the FFT; generating clusters by performing clustering on extracted spectral features; performing stratified sampling on the clusters; extracting a first time series from the stratified sampling, the first time series corresponding to temporal pattern coverage; and outputting the first time series into the test suite.

The method may also include further include pre-processing each time series in the test set before performing the FFT, by at least one of: detrending, deseasonalizing, windowing, normalization, or zero-padding. When extracting the spectral features, the method may further include normalizing amplitudes by a total spectral power of a respective time series. When generating cluster, the method may further include applying a clustering algorithm selected from the group consisting of k-means, hierarchical agglomerative clustering, Density-Based Spatial Clustering of Applications with Noise (DBSCAN), Gaussian mixture models, and spectral clustering. The method may also include where stratified sampling includes allocating samples proportional to cluster membership and enforcing a minimum number of samples per cluster.

The method may further include: sampling one or more outlier clusters; extracting a second time series corresponding to an outlier test case from sampling of the one or more outlier clusters; and combining the first time series and the second time series into the test suite. The method may further include identifying the one or more outlier clusters based on at least one criterion selected from singleton membership, silhouette score threshold, cluster density threshold, or distance from a cluster centroid exceeding a percentile. Other technical features may be readily apparent to one skilled in the art from the following figures, descriptions, and claims.

In one aspect, a computer-implemented method is provided for generating an adversarial test case for evaluating one or more machine-learning models trained on a first set of time series. The method includes: performing a Fast Fourier Transform (FFT) on a second set of time series in a test set; extracting top ‘K’ amplitudes and corresponding frequencies and phases of the FFT; generating clusters by performing clustering on extracted spectral features; performing stratified sampling on the clusters; perturbing a spectrum of one or more sample points corresponding to the stratified sampling; performing an inverse FFT to construct a first time series from the perturbed spectrum, the first time series corresponding to an adversarial test case’ and outputting the first time series into a test suite. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for FFT based test suite for time series models in accordance with one embodiment.

FIG. 2 illustrates a block diagram for generation of a FFT-based test suite for time series models in accordance with one embodiment.

FIG. 3 illustrates the concept of stratified sampling.

FIG. 4 illustrates a block diagram for generation of a FFT-based test suite for time series models in accordance with one embodiment.

FIG. 5 illustrates a block diagram for generation of a FFT based adversarial test case, in accordance with one embodiment.

FIG. 6 illustrates a block diagram for generation of a FFT-based test suite for time series models in accordance with one embodiment.

FIG. 7A illustrates reconstruction of a time series in accordance with one embodiment.

FIG. 7B illustrates a pair of spectral plots in accordance with one embodiment.

FIG. 8 illustrates reconstruction of a demand signal in accordance with one embodiment.

FIG. 9 illustrates clustering of store-item level SKUs based on FFT signatures, in accordance with one embodiment.

FIG. 10B illustrates an original time series and a reconstructed time series at a first city, in accordance with an embodiment.

FIG. 10B illustrates an original time series and a reconstructed time series at a second city, in accordance with an embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit including custom Very Large Scale Integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, include one or more physical or logical blocks of computer instructions which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM) or Flash memory, a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which includes one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, Electrically Erasable Programmable Read-Only Memory (EEPROM), and flash memory devices); CD-ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

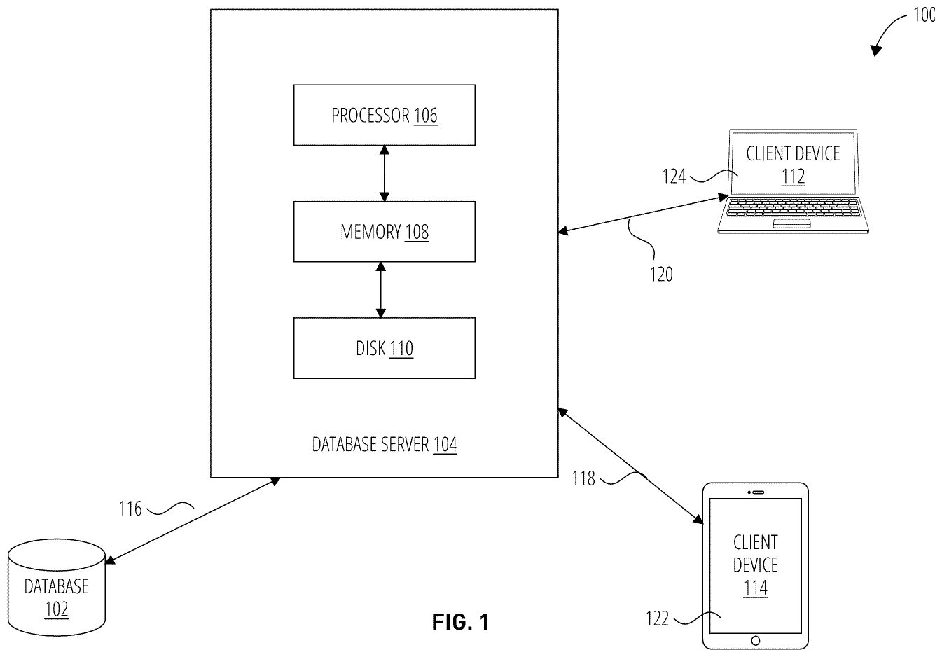

FIG. 1 illustrates an example of a system 100 for FFT based test suite for time series models in accordance with one embodiment.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVDs), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LANs), Wireless Local area networks (WLANs), wide area networks (WANs) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also include a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

A multi-horizon time series forecasting problem requires predicting over several future time intervals. For example, a machine learning model can be trained to forecast the next three months of sales for a product, using the previous three years of sales data. In real-world applications, this often scales to hundreds of thousands of time series, where forecasts are generated for many items simultaneously.

Before deploying such trained machine learning models, the performance of each is evaluated through backtesting, which is a critical step between model training and deployment. Backtesting simulates how a machine learning model would have performed historically by comparing its predictions with actual outcomes. For instance, if there is 39 months of data, the machine learning model can be trained on the first 36 months, while predicting months 37-39. These predictions are then compared with the actual data from months 37-39 to assess performance of the trained machine learning model, offering insight into how the model might perform when trained on all 39 months and tasked with forecasting months 40-42.

For robust evaluation, the backtesting test suite must cover a wide range of time series patterns, including variations in seasonality and trends, ensuring the model's resilience in production across diverse forecasting challenges. Disclosed herein are systems and methods of constructing a test suite which samples the time series to provide a good test coverage across different temporal patterns.

In addition, the systems and methods disclosed herein fit into an overall ML pipeline before deployment (backtesting & validation), by building and providing a rigorous test suite that mirrors real temporal diversity and adversarial scenarios. In addition, they can provide model monitoring & regression testing: when retraining or updating features, the test suite can be regenerated to catch performance regressions on tricky patterns.

A powerful tool for analyzing time series data is the Fast Fourier Transform (FFT), a mathematical algorithm that transforms a time-domain signal into its frequency-domain representation. FFT breaks down the signal into its constituent frequencies, revealing the underlying spectral components. By examining the resulting frequency spectrum, one can identify dominant frequencies that correspond to periodic elements within the time series. This analysis provides critical insights into the signal's patterns, such as cycles, trends, and seasonality.

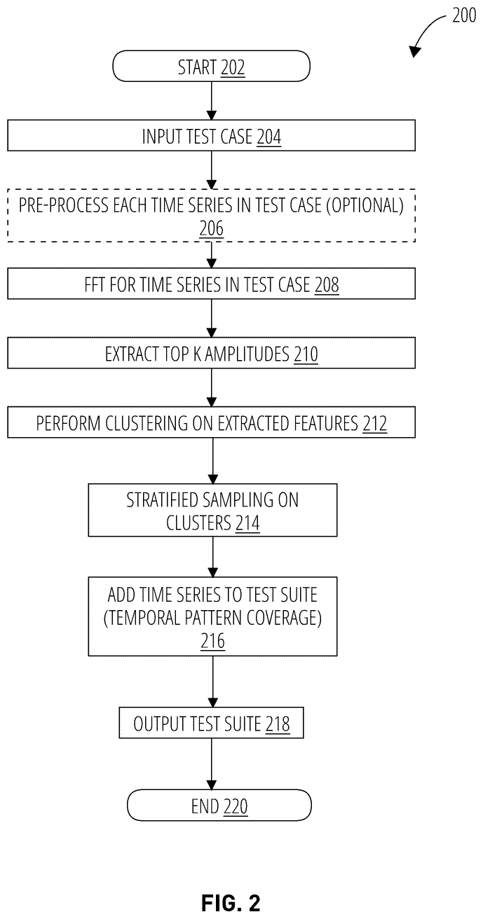

FIG. 2 illustrates a block diagram 200 for generation of a FFT-based test suite for time series models in accordance with one embodiment.

The process begins at 202, followed by input of a test case at block 204. The FFT for all time series signals in the test set can be performed at block 208. Optionally, before performing the FFT, each time series in the test set can be pre-processed at block 206; pre-processing can be by at least one of: detrending, deseasonalizing, windowing, normalization, and zero-padding. To build a robust test suite for time series models, the top K dominant frequencies can be extracted, along with their amplitudes and phases, from each time series in the dataset (excluding the training set) at block 210. These extracted features can act as temporal signatures of the data. In some embodiments, K can be an integer between 3 and 25. In some embodiments, extracting the spectral features can further include normalizing amplitudes by a total spectral power of the time series.

Subsequently, at block 212, clustering of these signals, based on its spectral attributes, can be performed. Clustering on these dominant features results in grouping time series based on similar seasonal patterns and periodic behaviors. By clustering time series in this manner, the diversity of temporal dynamics within the dataset can be captured. In some embodiments, generating clusters can include applying a clustering algorithm selected from the group consisting of k-means, hierarchical agglomerative clustering, Density-Based Spatial Clustering of Applications with Noise (DBSCAN), Gaussian mixture models, and spectral clustering. In embodiments where k-means is applied, the k-means can be initialized via k-means++ and a distance metric defined over (frequency, amplitude, phase) tuples.

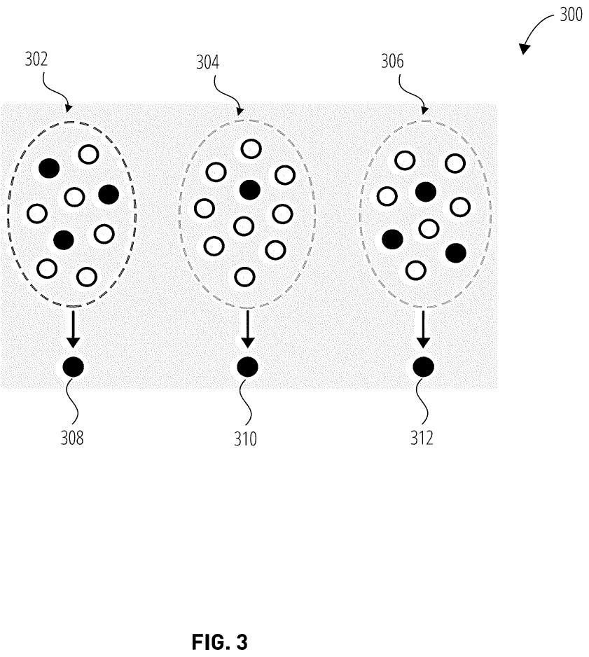

Once clusters are formed, stratified sampling can be applied over the clusters at block 214, towards population of a test suite. Stratified sampling is a statistical technique used to ensure that a sample accurately represents different subgroups (or strata) within a population. FIG. 3 illustrates the concept of stratified sampling. In some embodiments, stratified sampling can include allocating samples proportional to cluster membership and enforcing a minimum number of samples per cluster. After clustering time series by their dominant frequencies and patterns, each cluster is a stratum. Stratified sampling ensures the test suite includes representatives from every cluster, not just the most common seasonal patterns. Stratified sampling prevents bias toward large or common groups; ensures coverage of rare or edge cases and improves reliability of testing or analysis. This way, a ML model is tested on diverse temporal behaviors, improving robustness of the model.

Since these clusters are based on the temporal characteristics of the data, stratified sampling can ensure good test coverage by including a representative set of time series patterns. The time series corresponding to the sample cluster points are added to the test suite at block 216, thus providing temporal pattern coverage.

By leveraging the clusters to represent a diverse set of temporal patterns, a comprehensive and rigorous test suite can be built for time series models. This approach can ensure not only broad test coverage but also deep insights into the model's robustness and ability to handle complex, real-world data.

The stream of test suite data (block 216) can then be output to an overall test suite at block 218. The process ends at 220.

FIG. 3 illustrates the concept 300 of stratified sampling. Each oval represents a cluster of time-series patterns; cluster 302, cluster 304, and cluster 306. Each cluster consists of a series of data points, represented by circles contained within each oval. The arrows indicated that a sample is taken from each cluster, ensuring that all groups are represented in the final sample.

There are different ways of sampling each cluster, such as proportional allocation, equal allocation, and minimum quota+proportional. In proportional allocation, each cluster contributes samples in proportion to the size of the cluster-that is, the number of data points in the cluster. As an example, if Cluster 302 has 50% of the data, Cluster 304 has 30%, and Cluster 306 has 20%, then for a total of 100 samples: 50 samples (308) are extracted from Cluster 302; 30 samples (310) are extracted from Cluster 304; and 20 samples (312) are extracted from Cluster 306. In this approach, large clusters dominate the sample. In equal allocation, each cluster contributes the same number of samples, regardless of size. This is useful for balanced representation, even for small clusters. However, small clusters may be overrepresented. In minimum quota+proportional, at least one or two samples are extracted per cluster, followed by allocating the remaining proportionally. This prevents rare clusters from being excluded, and is good for overall coverage and fairness.

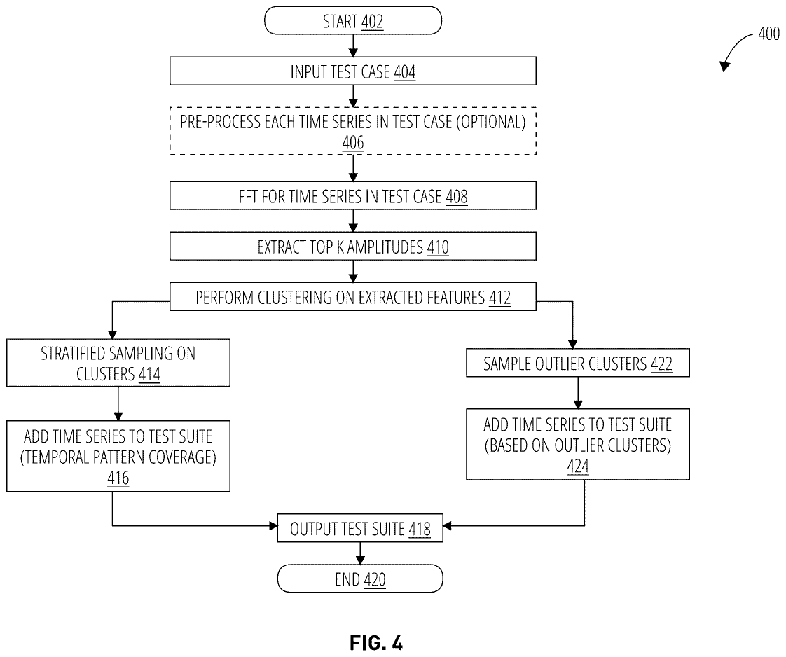

In some embodiments of the block diagram shown in FIG. 4, after clustering time series by FFT features, proportional allocation with a minimum quota can be used, to ensure that large clusters don't dominate and that rare seasonal patterns (edge cases) can be included.

Performing clustering on extracted features also provides an opportunity to sample outlier clusters. FIG. 4 illustrates a block diagram 400 for generation of a FFT-based test suite for time series models in accordance with one embodiment.

The process begins at 402, followed by input of a test case at block 404. The FFT for all time series signals in the test set can be performed at block 408. Optionally, before performing the FFT, each time series in the test set can be pre-processed at block 406; pre-processing can be by at least one of: detrending, deseasonalizing, windowing, normalization, and zero-padding. To build a robust test suite for time series models, the top K dominant frequencies can be extracted, along with their amplitudes and phases, from each time series in the dataset (excluding the training set) at block 410. These extracted features can act as temporal signatures of the data. In some embodiments, K can be an integer between 3 and 25. In some embodiments, extracting the spectral features can further include normalizing amplitudes by a total spectral power of the time series.

Subsequently, at block 412, clustering of these signals, based on its spectral attributes, can be performed. Clustering on these dominant features results in grouping time series based on similar seasonal patterns and periodic behaviors. By clustering time series in this manner, the diversity of temporal dynamics within the dataset can be captured. In some embodiments, generating clusters can include applying a clustering algorithm selected from the group consisting of k-means, hierarchical agglomerative clustering, DBSCAN, Gaussian mixture models, and spectral clustering. In embodiments where k-means is applied, the k-means can be initialized via k-means++ and a distance metric defined over (frequency, amplitude, phase) tuples.

Once clusters are formed, stratified sampling can be applied over the clusters at block 414, towards population of a test suite. Stratified sampling is a statistical technique used to ensure that a sample accurately represents different subgroups (or strata) within a population. FIG. 3 illustrates the concept of stratified sampling. In some embodiments, stratified sampling can include allocating samples proportional to cluster membership and enforcing a minimum number of samples per cluster. After clustering time series by their dominant frequencies and patterns, each cluster is a stratum. Stratified sampling ensures the test suite includes representatives from every cluster, not just the most common seasonal patterns. Stratified sampling prevents bias toward large or common groups; ensures coverage of rare or edge cases and improves reliability of testing or analysis. This way, a ML model is tested on diverse temporal behaviors, improving robustness of the model.

Since these clusters are based on the temporal characteristics of the data, stratified sampling can ensure good test coverage by including a representative set of time series patterns. The time series corresponding to the sample cluster points are added to the test suite at block 416, thus providing temporal pattern coverage.

By analyzing the clusters, it can be possible to identify outlier clusters that represent unusual or extreme temporal patterns, such as rare seasonal shifts or highly irregular periodic behaviors. As an example, in time-series forecasting, an edge case might be a product that only sells during holidays or a sudden spike that doesn't follow the usual weekly pattern. In some embodiments, identifying outlier clusters can be based on at least one criterion selected from singleton membership, silhouette score threshold, cluster density threshold, or distance from a cluster centroid exceeding a percentile. Sampling outlier clusters can be performed at block 422. The time series corresponding to the sampled outlier cluster points are then added to the test suite at block 424. These outlier clusters can serve as a source of edge cases—testing scenarios where the model might struggle due to the presence of rare or unexpected patterns. Including these edge cases in the test suite ensures that the model is tested against difficult, uncommon situations that are likely to challenge its predictive ability.

By leveraging the clusters to both represent a diverse set of temporal patterns and generate edge cases, a comprehensive and rigorous test suite can be built for time series models. This approach can ensure not only broad test coverage but also deep insights into the model's robustness and ability to handle complex, real-world data.

The two streams of test suite data (block 416 and block 424) can then be combined and output to an overall test suite at block 418. The process ends at 420.

### Adversarial Testing

While FFT can primarily serve feature engineering, it can also be leveraged for adversarial testing. Disclosed herein are systems and methods that leverage FFT for adversarial testing. Adversarial testing is a technique used in machine learning (ML). It involves intentionally feeding a model inputs designed to trick it into making incorrect predictions. These “adversarial examples” can be subtle perturbations to normal inputs, making them difficult for humans to detect. There are many reasons to perform adversarial testing, a few of which are discussed below.

Sensitivity to Noise: Time series data is often noisy, and adversarial attacks can exploit this sensitivity by introducing carefully crafted perturbations that the model might misinterpret.

Temporal Dependencies: Time series models rely on temporal dependencies between data points. Adversarial attacks can target these dependencies by manipulating specific points or introducing patterns that disrupt the model's ability to learn from the data.

There are many potential opportunities for Adversarial Testing, such as Frequency Domain Manipulation. This can include Noise Injection; here, introducing high-frequency noise can disrupt an ML model's ability to recognize patterns in the frequency domain. This can also include Frequency Shift; here, shifting the frequencies of the input data can confuse the model, as it might not be trained to handle such variations.

Adversarial Examples can include FFT-Based Perturbations and Frequency-Domain Attacks. In the case of FFT-Based Perturbations, by applying FFT to the input data, frequency components that are crucial for the model's predictions can be identified. Manipulating these components can create adversarial examples that the model misclassifies. In the case of Frequency-Domain Attacks, targeting specific frequency bands can lead to targeted attacks, where the ML model is tricked into making specific misclassifications.

Adversarial Examples can also include Defense Mechanisms, such as Frequency-Domain Regularization and FFT-Based Detection. In the case of Frequency-Domain Regularization, encouraging the ML model to learn robust features in the frequency domain can make it more resistant to adversarial attacks. In the case of FFT-Based Detection, monitoring the frequency components of input data can help detect anomalies or potential adversarial attacks.

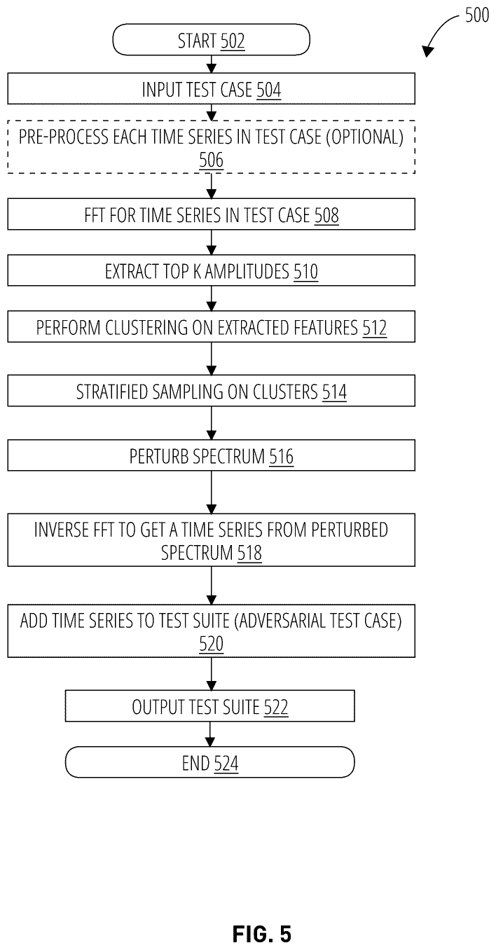

FIG. 5 illustrates a block diagram 500 for generation of a FFT based adversarial test case, in accordance with one embodiment.

While FFT can primarily serve feature engineering, it can also be leveraged for adversarial testing. Disclosed herein are systems and methods that leverage FFT for adversarial testing. The process begins at 502, followed by input of a test case at block 504. The FFT for all timeseries signals in the test set is performed at block 508. Optionally, before performing the FFT, each time series in the test set can be pre-processed at block 506; pre-processing can be by at least one of: detrending, deseasonalizing, windowing, normalization, and zero-padding. To build a robust test suite for time series models, the top K dominant frequencies are extracted, along with their amplitudes and phases, from each time series in the dataset (excluding the training set) at block 510. These extracted features act as temporal signatures of the data. In some embodiments, K can be an integer between 3 and 25. In some embodiments, extracting the spectral features can further include normalizing amplitudes by a total spectral power of the time series.

Subsequently, at block 512, clustering of these signals, based on its spectral attributes, are performed. Clustering on these dominant features results in grouping time series based on similar seasonal patterns and periodic behaviors. By clustering time series in this manner, the diversity of temporal dynamics within the dataset can be captured. In some embodiments, generating clusters can include applying a clustering algorithm selected from the group consisting of k-means, hierarchical agglomerative clustering, DBSCAN, Gaussian mixture models, and spectral clustering. In embodiments where k-means is applied, the k-means can be initialized via k-means++ and a distance metric defined over (frequency, amplitude, phase) tuples.

Once clusters are formed, stratified sampling can be applied over the clusters at block 514, towards population of a test suite. FIG. 3 illustrates the concept of stratified sampling. In some embodiments, stratified sampling can include allocating samples proportional to cluster membership and enforcing a minimum number of samples per cluster. However, beyond simply ensuring broad coverage, these clusters can also provide an opportunity to generate adversarial examples for more rigorous testing.

Adversarial cases can be created by manipulating the time series data within each cluster. For example, small perturbations can be introduced to the dominant frequencies, amplitudes, or phases of the time series at block 516. This can create slightly modified versions of the original data that might expose weaknesses in the model's ability to generalize. In some embodiments, perturbing the spectrum can include modifying at least one of: a frequency component, an amplitude component, or a phase component. In some embodiments, perturbing the spectrum can include introducing a random noise component to at least one of the extracted frequencies, amplitudes, or phases. In some embodiments, perturbing the spectrum can include shifting one or more dominant frequencies by a predefined offset within a tolerance range. In some embodiments, perturbing the spectrum can include scaling one or more amplitude values by a factor selected from a range between 0.8 and 1.2. In some embodiments, perturbing the spectrum can include modifying phase values by adding a random phase shift selected from a uniform distribution. In some embodiments, perturbing the spectrum can include applying a Gaussian noise distribution to amplitude values while preserving the original frequency components. In some embodiments, perturbing the spectrum can include selectively perturbing only the top ‘K’ dominant frequency components while leaving remaining components unchanged.

Next, at block 518, an inverse FFT can be performed to construct a time series from the perturbed spectrum. This time series, representing an adversarial test case, can then be added to the test suite at block 520. These adversarial cases are designed to stress-test the model by forcing it to make predictions under altered conditions that still retain the core temporal structure of the data. This process helps identify potential vulnerabilities in the model's performance under adversarial conditions.

The time series generated at block 520 can be added to an overall test suite at block 522. The process ends at 524.

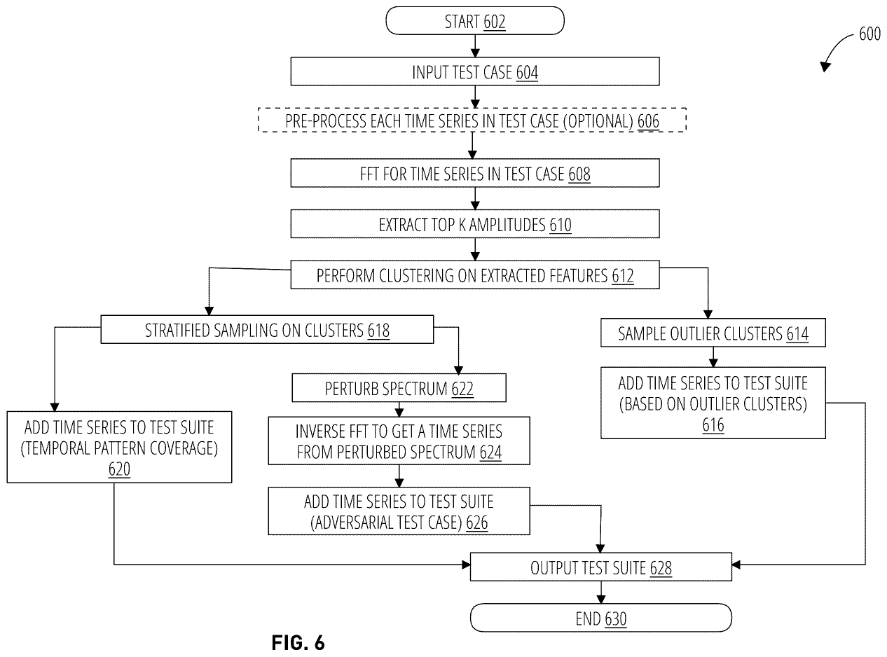

FIG. 6 illustrates a block diagram 600 for generation of a FFT-based test suite for time series models in accordance with one embodiment. In FIG. 6, three streams are combined into one automated test suite that includes coverage samples (representative clusters), adversarial samples (perturbed spectra), and outlier clusters (rare temporal patterns), thereby providing a comprehensive and systematic approach to testing time series ML models.

The process begins at 602, followed by input of a test case at block 604. The FFT for all time series signals in the test set is performed at block 608. Optionally, before performing the FFT, each time series in the test set can be pre-processed at block 606; pre-processing can be by at least one of: detrending, deseasonalizing, windowing, normalization, and zero-padding. To build a robust test suite for time series models, the top K dominant frequencies are extracted, along with their amplitudes and phases, from each time series in the dataset (excluding the training set) at block 610. These extracted features act as temporal signatures of the data. In some embodiments, K can be an integer between 3 and 25. In some embodiments, extracting the spectral features can further include normalizing amplitudes by a total spectral power of the time series.

Subsequently, at block 612, clustering of these signals, based on its spectral attributes, are performed. Clustering on these dominant features results in grouping time series based on similar seasonal patterns and periodic behaviors. By clustering time series in this manner, the diversity of temporal dynamics within the dataset can be captured. In some embodiments, generating clusters can include applying a clustering algorithm selected from the group consisting of k-means, hierarchical agglomerative clustering, DBSCAN, Gaussian mixture models, and spectral clustering. In embodiments where k-means is applied, the k-means can be initialized via k-means++ and a distance metric defined over (frequency, amplitude, phase) tuples.

Once clusters are formed, stratified sampling can be applied over the clusters at block 618, towards population of a test suite. FIG. 3 illustrates the concept of stratified sampling. In some embodiments, stratified sampling can include allocating samples proportional to cluster membership and enforcing a minimum number of samples per cluster. Since these clusters are based on the temporal characteristics of the data, stratified sampling can ensure good test coverage by including a representative set of time series patterns. The time series corresponding to the sample cluster points are added to the test suite at block 620, thus providing temporal pattern coverage.

However, beyond simply ensuring broad coverage, these clusters can also provide an opportunity to generate edge cases and adversarial examples for more rigorous testing.

Adversarial cases can be created by manipulating the time series data within each cluster. For example, small perturbations can be introduced to the dominant frequencies, amplitudes, or phases of the time series at block 622. This can create slightly modified versions of the original data that might expose weaknesses in the model's ability to generalize. In some embodiments, perturbing the spectrum can include modifying at least one of: a frequency component, an amplitude component, or a phase component. In some embodiments, perturbing the spectrum can include introducing a random noise component to at least one of the extracted frequencies, amplitudes, or phases. In some embodiments, perturbing the spectrum can include shifting one or more dominant frequencies by a predefined offset within a tolerance range. In some embodiments, perturbing the spectrum can include scaling one or more amplitude values by a factor selected from a range between 0.8 and 1.2. In some embodiments, perturbing the spectrum can include modifying phase values by adding a random phase shift selected from a uniform distribution. In some embodiments, perturbing the spectrum can include applying a Gaussian noise distribution to amplitude values while preserving the original frequency components. In some embodiments, perturbing the spectrum can include selectively perturbing only the top ‘K’ dominant frequency components while leaving remaining components unchanged.

Next, at block 624, an inverse FFT is performed to construct a time series from the perturbed spectrum. This time series, representing an adversarial test case, is then added to the test suite at block 626. These adversarial cases are designed to stress-test the model by forcing it to make predictions under altered conditions that still retain the core temporal structure of the data. This process helps identify potential vulnerabilities in the model's performance under adversarial conditions.

By analyzing the clusters, it can be possible to identify outlier clusters that represent unusual or extreme temporal patterns, such as rare seasonal shifts or highly irregular periodic behaviors. In some embodiments, identifying outlier clusters can be based on at least one criterion selected from singleton membership, silhouette score threshold, cluster density threshold, or distance from a cluster centroid exceeding a percentile. Sampling outlier clusters is performed at block 614. The time series corresponding to the sampled outlier cluster points are then added to the test suite at block 616. These outlier clusters can serve as a source of edge cases—testing scenarios where the model might struggle due to the presence of rare or unexpected patterns. Including these edge cases in the test suite ensures that the model is tested against difficult, uncommon situations that are likely to challenge its predictive ability.

By leveraging the clusters to both represent a diverse set of temporal patterns and generate edge and adversarial cases, a comprehensive and rigorous test suite can be built for time series models. This approach can ensure not only broad test coverage but also deep insights into the model's robustness and ability to handle complex, real-world data.

The three streams of test suite data (block 626, block 616 and block 620) are then combined and output to an overall test suite at block 628. The process ends at 630.

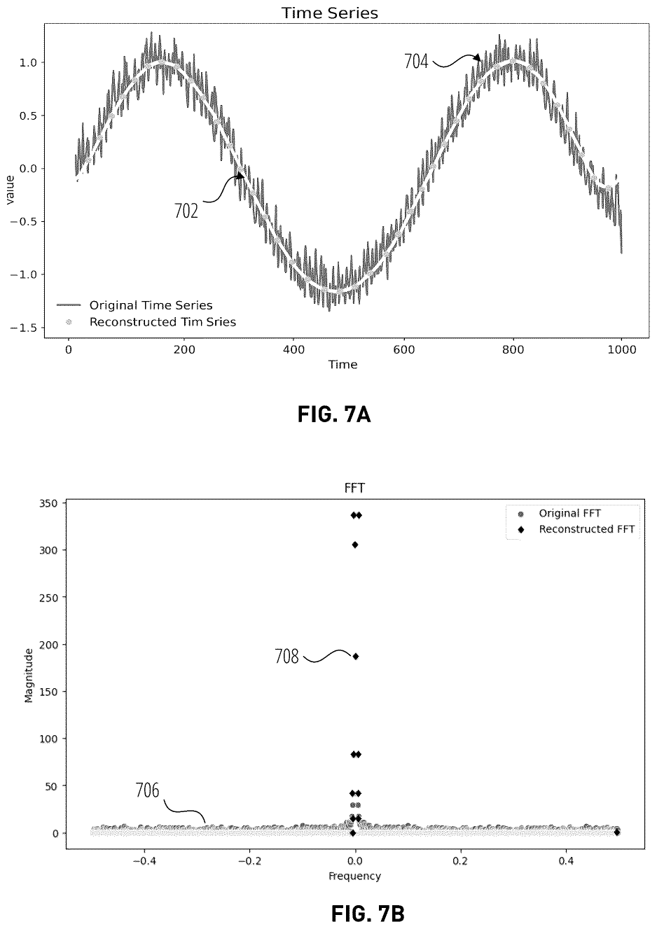

FIG. 7A illustrates reconstruction of a time series in accordance with one embodiment. The reconstruction curve 702 successfully captures the primary sinusoidal pattern from the noisy input signal 704. By retaining only the top 10 frequency components with the highest magnitudes, the algorithm preserves the dominant signal characteristics while discarding low-magnitude components (which in this case represent noise). This demonstrates the ability to compress time series data while maintaining signal fidelity.

FIG. 7B illustrates a pair of spectral plots in accordance with one embodiment. Spectral plot 706 illustrates the distribution of frequency components in the original signal. The spectral plot 708 consists of the 10 selected frequencies for reconstruction (black diamonds) that correspond to the components with the highest magnitudes across the entire frequency spectrum. These 10 selected frequencies are used to construct the reconstruction curve 702 in FIG. 7A.

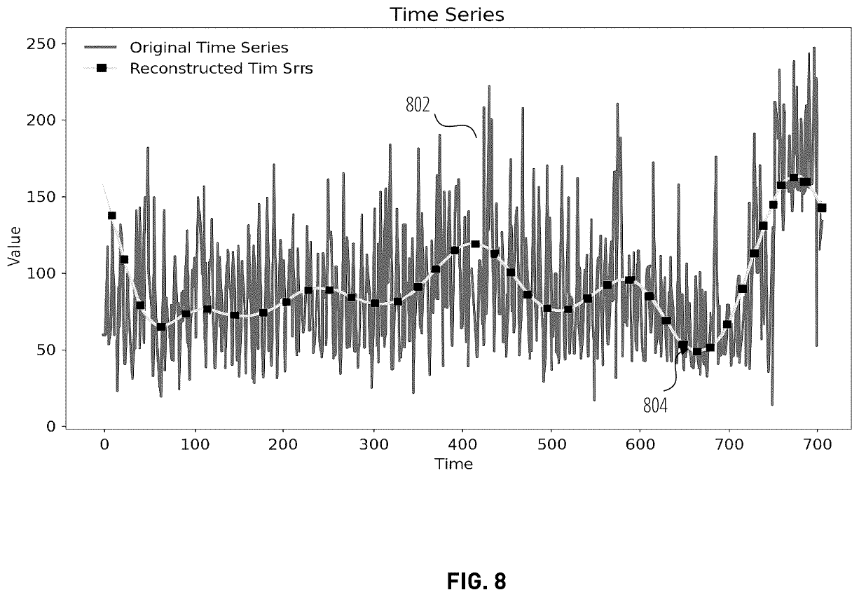

FIG. 8 illustrates reconstruction of a demand signal in accordance with one embodiment. When applied to actual sales data 802 (in the restaurant industry), the reconstruction signal 804 effectively captures the underlying demand patterns. By selecting the frequency components with the highest magnitudes, the algorithm identifies and preserves the most significant cyclical trends and patterns while discarding low-magnitude components that contribute less to the overall signal structure.

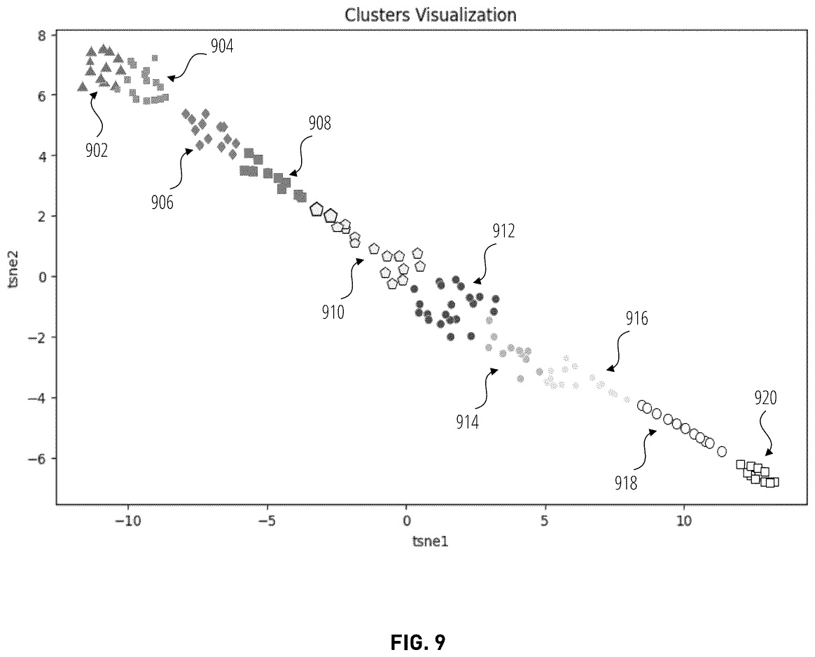

FIG. 9 illustrates clustering of store-item level SKUs based on FFT signatures, in accordance with one embodiment. Store-item level SKUs were clustered using only FFT-derived features (top-10 spectral frequencies with their corresponding magnitudes and phases). Importantly, no item attributes or location metadata were included in the clustering algorithm. T-SNE (t-distributed Stochastic Neighbor Embedding) was applied to visualize the high-dimensional FFT feature space in two dimensions. The algorithm successfully groups SKUs with similar temporal patterns, independent of product category or geographic location. Clusters labelled as 902, 904, 906, 908, 910, 912, 914, 916, 918 and 920 are shown.

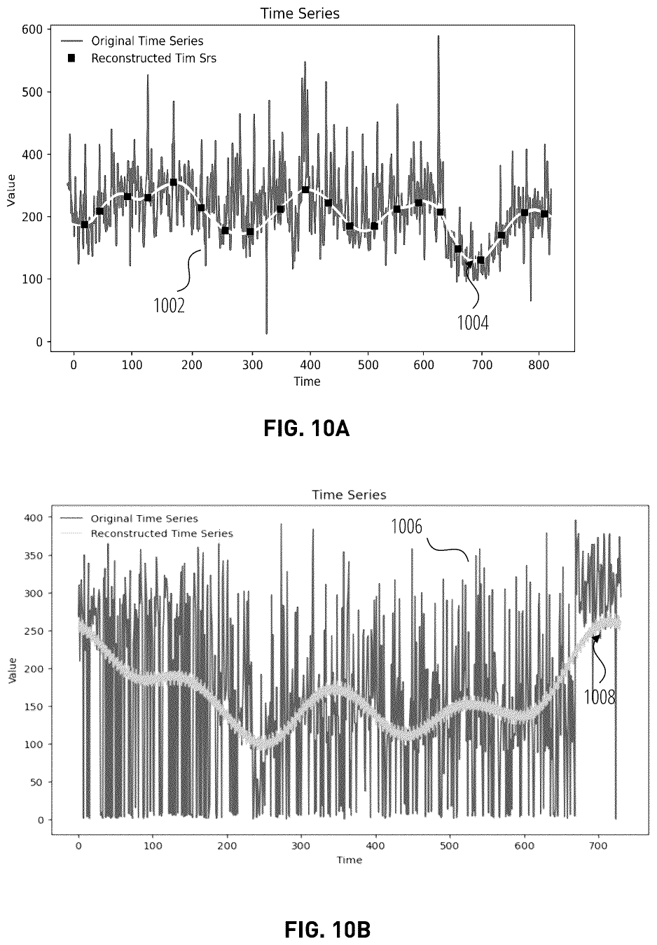

FIG. 10A and FIG. 10B illustrate examination of random cluster membership in accordance with one embodiment. Two random timeseries signal belonging to the same cluster group are shown in FIG. 10A and FIG. 10B. The clustering algorithm identified a sales item from two geographically distinct locations—a first city and a second city—as members of the same cluster, despite using zero location or product metadata. FIG. 10A illustrates the original time series 1002 at the first city; the reconstructed time series at the first city is shown as 1004.

FIG. 10B illustrates the original time series 1006 at the second city; the reconstructed time series at the second city is shown as 1008.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

The solution begins by computing FFT for all timeseries signals in the test set. Following which clustering of these signals based on its spectral attributes are performed. Once the clusters are formed, the solution performs stratified sampling of the clusters to prepare a test suite which ensures broad test coverage across temporal patterns. These clusters are also used to prepare edges test cases and adversarial test cases as mentioned in the above section.

What is claimed is:

1. A computing apparatus comprising:
a processor; and
a memory storing instructions that, when executed by the processor, configure the apparatus to:
perform a Fast Fourier Transform (FFT) on a second set of time series in a test set;
extract top ‘K’ amplitudes and corresponding frequencies and phases of the FFT;
generate clusters by performing clustering on extracted spectral features;
perform stratified sampling on the clusters;
extract a first time series from the stratified sampling, the first time series corresponding to temporal pattern coverage;
and
output the first time series into the test suite.

2. The computing apparatus of claim 1, wherein the instructions further configure the apparatus to:
pre-process each time series in the test set before performing the FFT, by at least one of: detrending, deseasonalizing, windowing, normalization, or zero-padding.

3. The computing apparatus of claim 1, wherein when extracting the spectral features, the apparatus is further configured to:
normalize amplitudes by a total spectral power of a respective time series.

4. The computing apparatus of claim 1, wherein when generating the clusters, the apparatus is further configured to:
apply a clustering algorithm selected from the group consisting of k-means, hierarchical agglomerative clustering, Density-Based Spatial Clustering of Applications with Noise (DBSCAN), Gaussian mixture models, and spectral clustering.

5. The computing apparatus of claim 1, wherein when stratified sampling, the apparatus is further configured to:
allocate samples proportional to cluster membership and enforce a minimum number of samples per cluster.

6. The computing apparatus of claim 1, wherein the instructions further configure the apparatus to:
sample one or more outlier clusters;
extract a second time series corresponding to an outlier test case from sampling of the one or more outlier clusters;
and
combine the first time series and the second time series into the test suite.

7. The computing apparatus of claim 6, wherein the instructions further configure the apparatus to:
identify the one or more outlier clusters based on at least one criterion selected from singleton membership, silhouette score threshold, cluster density threshold, or distance from a cluster centroid exceeding a percentile.

8. A non-transitory computer-readable storage medium, the computer-readable storage medium including instructions that when executed by a computer, cause the computer to:
perform a Fast Fourier Transform (FFT) on a second set of time series in a test set;
extract top ‘K’ amplitudes and corresponding frequencies and phases of the FFT;
generate clusters by performing clustering on extracted spectral features;
perform stratified sampling on the clusters;
extract a first time series from the stratified sampling, the first time series corresponding to temporal pattern coverage;
and
output the first time series into the test suite.

9. The computer-readable storage medium of claim 8, wherein the instructions further configure the computer to pre-process each time series before performing the FFT in the test set, by at least one of: detrending, deseasonalizing, windowing, normalization, or zero-padding.

10. The computer-readable storage medium of claim 8, wherein when extracting the spectral features, the instructions further configure the computer to:
normalize amplitudes by a total spectral power of a respective time series.

11. The computer-readable storage medium of claim 8, wherein when generating the clusters, the instructions further configure the computer to:
apply a clustering algorithm selected from the group consisting of k-means, hierarchical agglomerative clustering, Density-Based Spatial Clustering of Applications with Noise (DBSCAN), Gaussian mixture models, and spectral clustering.

12. The computer-readable storage medium of claim 8, wherein when stratified sampling, the instructions further configure the computer to:
allocate samples proportional to cluster membership and enforce a minimum number of samples per cluster.

13. The computer-readable storage medium of claim 8, wherein the instructions further configure the computer to:
sample one or more outlier clusters;
extract a second time series corresponding to an outlier test case from sampling of the one or more outlier clusters;
and
combine the first time series and the second time series into the test suite.

14. The computer-readable storage medium of claim 13, wherein the instructions further configure the computer to:
identify the one or more outlier clusters based on at least one criterion selected from singleton membership, silhouette score threshold, cluster density threshold, or distance from a cluster centroid exceeding a percentile.

15. A computer-implemented method for generating a test suite for evaluating one or more machine-learning models trained on a first set of time series, the method comprising:
performing a Fast Fourier Transform (FFT) on a second set of time series in a test set;
extracting top ‘K’ amplitudes and corresponding frequencies and phases of the FFT;
generating clusters by performing clustering on extracted spectral features;
performing stratified sampling on the clusters;
extracting a first time series from the stratified sampling, the first time series corresponding to temporal pattern coverage;
and
outputting the first time series into the test suite.

16. The method of claim 15, further comprising pre-processing each time series in the test set before performing the FFT, by at least one of: detrending, deseasonalizing, windowing, normalization, or zero-padding.

17. The method of claim 15, wherein extracting the spectral features further comprises normalizing amplitudes by a total spectral power of a respective time series.

18. The method of claim 15, wherein generating clusters comprises applying a clustering algorithm selected from the group consisting of k-means, hierarchical agglomerative clustering, Density-Based Spatial Clustering of Applications with Noise (DBSCAN), Gaussian mixture models, and spectral clustering.

19. The method of claim 15, wherein stratified sampling comprises allocating samples proportional to cluster membership and enforcing a minimum number of samples per cluster.

20. The method of claim 15, further comprising:
sampling one or more outlier clusters;
extracting a second time series corresponding to an outlier test case from sampling of the one or more outlier clusters;
and
combining the first time series and the second time series into the test suite.

21. The method of claim 20, further comprising:
identifying the one or more outlier clusters based on at least one criterion selected from singleton membership, silhouette score threshold, cluster density threshold, or distance from a cluster centroid exceeding a percentile.

22. A computer-implemented method for generating an adversarial test case for evaluating one or more machine-learning models trained on a first set of time series, the method comprising:
performing a Fast Fourier Transform (FFT) on a second set of time series in a test set;
extracting top ‘K’ amplitudes and corresponding frequencies and phases of the FFT;
generating clusters by performing clustering on extracted spectral features;
performing stratified sampling on the clusters;
perturbing a spectrum of one or more sample points corresponding to the stratified sampling;
performing an inverse FFT to construct a first time series from the perturbed spectrum, the first time series corresponding to an adversarial test case; and
outputting the first time series into a test suite.
